(19) United States
(12) Patent Application Publication
(10) Pub. No.: US 2025/0187673 A1
(43) Pub. Date: Jun. 12, 2025

(54) VEHICLE BODY FRONT STRUCTURE

(71) Applicants: Hyundai Motor Company, Seoul (KR); Kia Corporation, Seoul (KR)

(72) Inventors: Ji Woong Park, Hwaseong-si (KR); Il Do Kim, Hwaseong-si (KR); Sun Ju Lee, Hwaseong-si (KR)

(21) Appl. No.: 18/811,358

(22) Filed: Aug. 21, 2024

(30) Foreign Application Priority Data
Dec. 6, 2023 (KR) 10-2023-0176007

(51) Int. Cl. B62D 25/14; B62D 27/02

(52) U.S. Cl. CPC B62D 25/145; B62D 27/02

(57) ABSTRACT

An embodiment vehicle body front structure includes a dash crossmember including a cross portion extending in a width direction of a vehicle and a pair of outrigger portions disposed at both ends of the cross portion, a pair of front side members extending from the pair of outrigger portions toward the front of the vehicle, wherein each outrigger portion of the pair of outrigger portions includes a front connection portion having a cavity capable of receiving a rear portion of the corresponding front side member of the pair of front side members, and a plurality of reinforcing pipes disposed in the rear portion of each front side member of the pair of front side members, each reinforcing pipe of the plurality of reinforcing pipes extending in a width direction of the front side member.

### CROSS-REFERENCE TO RELATED APPLICATIONS

This application claims the benefit of Korean Patent Application No. 10-2023-0176007, filed on Dec. 6, 2023, which application is hereby incorporated herein in its entirety by reference.

### TECHNICAL FIELD

The present disclosure relates to a vehicle body front structure.

### BACKGROUND

A vehicle may include a dash panel and a dash crossmember by which a passenger compartment and a front compartment are partitioned. A powertrain system including a prime mover may be disposed in the front compartment. For example, an internal combustion engine vehicle may have a mechanical powertrain system including an internal combustion engine and a transmission in the front compartment, and an electric vehicle may have an electric powertrain system including an electric motor, an inverter, and a transmission in the front compartment. The dash crossmember may be mounted at a front edge of a floor panel, and the dash panel may be connected to a top edge of the dash crossmember. The dash crossmember may extend in a width direction of the vehicle.

Due to an increase in vehicle complexity, integration of vehicle body components/parts continues to be required. A casting method such as a high-vacuum die casting method is advantageous for the integration of vehicle body components/parts, and a demand therefor is increasing. For example, the dash crossmember according to the related art may have a closed cross section through a pressing method, a joining method, and the like, thereby meeting its target stiffness. However, as the plurality of components are manufactured by a pressing method and are joined using fasteners, welding, and/or the like, the manufacturing process of the dash crossmember may become very complex, and the manufacturing cost thereof may be relatively increased. Accordingly, the dash crossmember may be designed to have an open cross section including a plurality of ribs formed thereon so that the dash crossmember may be easily manufactured by a casting method and stiffness of the dash crossmember may be obtained.

Since the electric vehicle includes a battery disposed below the floor panel, the weight thereof may increase compared to the weight of the internal combustion engine vehicle. Accordingly, impact energy may increase in the event of a vehicle collision/impact, but a space for absorbing impact energy may be relatively reduced.

To solve these problems, structural members such as the dash crossmember may be integrated with peripheral components to thereby increase stiffness of the vehicle body, and it may be necessary to improve impact absorption performance using front side members.

The above information described in this background section is provided to assist in understanding the background of the inventive concept and may include any technical concept which is not considered as the already known prior art.

### SUMMARY

The present disclosure relates to a vehicle body front structure. Particular embodiments relate to a vehicle body front structure designed to firmly connect front side members for impact absorption and a dash crossmember for protection of a passenger compartment, thereby improving crashworthiness and securing safety of the passenger compartment.

Embodiments of the present disclosure can solve problems occurring in the prior art while advantages achieved by the prior art are maintained intact.

An embodiment of the present disclosure provides a vehicle body front structure designed to firmly connect front side members for impact absorption and a dash crossmember for protection of a passenger compartment, thereby improving crashworthiness and securing safety of the passenger compartment.

According to an embodiment of the present disclosure, a vehicle body front structure may include a dash crossmember including a cross portion extending in a width direction of a vehicle and a pair of outrigger portions provided at both ends of the cross portion, a pair of front side members extending from the pair of outrigger portions toward the front of the vehicle, and a plurality of reinforcing pipes disposed in a rear portion of each front side member. Each outrigger portion may include a front connection portion having a cavity receiving the rear portion of the corresponding front side member, and each reinforcing pipe may extend in a width direction of the front side member.

The vehicle body front structure may further include a pair of outer plates fixed to the pair of outrigger portions, respectively. Each outer plate may have a front extension portion mounted on the front connection portion of the corresponding outrigger portion.

The front connection portion of each outrigger portion and the front extension portion of the corresponding outer plate may be fixed to the plurality of reinforcing pipes by fasteners.

The front extension portion of each outer plate may be fixed to the rear portion of the front side member by a first bolt screwed into a first end portion of each reinforcing pipe.

The front connection portion of each outrigger portion may be fixed to the rear portion of the front side member by a second bolt screwed into a second end portion of each reinforcing pipe.

The front connection portion may further include a support wall aligned with the rear portion of the front side member.

The support wall may have an upper inclined portion extending obliquely from a top wall of the front connection portion at a predetermined angle and a lower inclined portion extending obliquely from a bottom wall of the front connection portion at a predetermined angle. The upper inclined portion and the lower inclined portion may have a symmetrical shape, and a bottom end of the upper inclined portion may be integrally connected to a top end of the lower inclined portion.

The rear portion of the front side member may have an upper inclined surface and a lower inclined surface provided on an end surface thereof. The upper inclined surface may be aligned with the upper inclined portion, and the lower inclined surface may be aligned with the lower inclined portion.

Each outrigger portion may include a plurality of reinforcing ribs aligned with the front side member, and each reinforcing rib may extend in a longitudinal direction of the front side member.

The plurality of reinforcing pipes may be arranged in a shape corresponding to the support wall.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a perspective view of a vehicle body front structure according to an exemplary embodiment of the present disclosure;

FIG. 2 illustrates a side view of the vehicle body front structure illustrated in FIG. 1;

FIG. 3 illustrates a cross-sectional view, taken along line A-A of FIG. 2; and

FIG. 4 illustrates a state in which a front side member and an outrigger portion are connected in a vehicle body front structure according to an exemplary embodiment of the present disclosure, from which an outer plate is removed.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

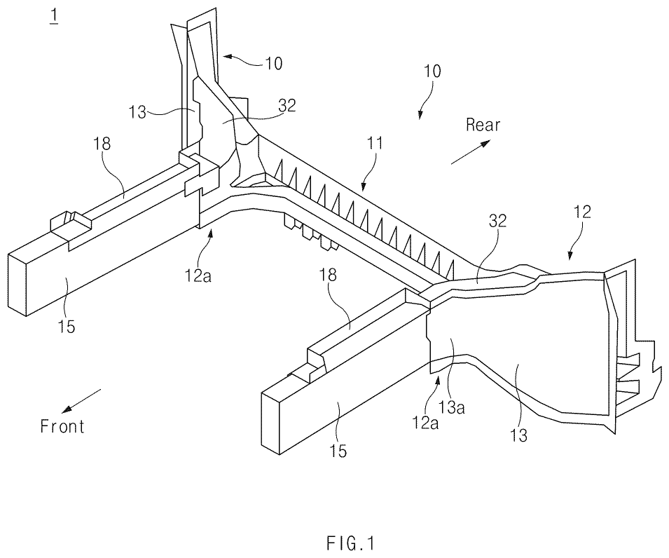

Referring to FIG. 1, a vehicle body front structure 1 according to an exemplary embodiment of the present disclosure may include a dash crossmember 10 extending in a width direction of the vehicle and a pair of front side members 15 extending from the dash crossmember 10 toward the front of the vehicle.

The dash crossmember 10 may be mounted at a front edge of a floor panel, and a dash panel may be mounted at a top edge of the dash crossmember 10. The dash panel may partition a front compartment of the vehicle from a passenger compartment of the vehicle. A powertrain system including a prime mover may be disposed in the front compartment. For example, an internal combustion engine vehicle may have a mechanical powertrain system including an internal combustion engine and a transmission in the front compartment, and an electric vehicle may have an electric powertrain system including an electric motor, an inverter, and a transmission in the front compartment.

Referring to FIG. 1, the dash crossmember 10 may include a cross portion 11 extending in the width direction of the vehicle and a pair of outrigger portions 12 provided at both ends of the cross portion 11. The dash crossmember 10 may be manufactured by a casting method such as a high-vacuum die casting method so that the cross portion 11 and the outrigger portions 12 may form a unitary one-piece structure.

Referring to FIG. 1, the pair of outrigger portions 12 may be provided at both ends of the cross portion 11, and rear end portions of a pair of front side members 15 may be connected to the pair of outrigger portions 12, respectively. A gap between front ends of the pair of outrigger portions 12 may be less than a gap between rear ends of the pair of outrigger portions 12.

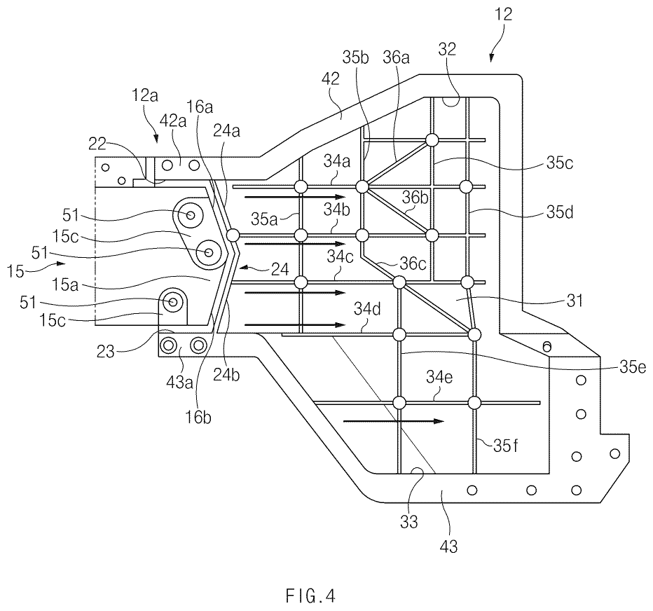

Referring to FIG. 4, each outrigger portion 12 may include a sidewall 31, a top wall 32 provided at a top edge of the sidewall 31, and a bottom wall 33 provided at a bottom edge of the sidewall 31. Each outrigger portion 12 may have a cavity defined by the sidewall 31, the top wall 32, and the bottom wall 33, and the cavity of the outrigger portion 12 may be open to the exterior of the vehicle. In addition, each outrigger portion 12 may include a top flange 42 provided on the top wall 32 and a bottom flange 43 provided on the bottom wall 33.

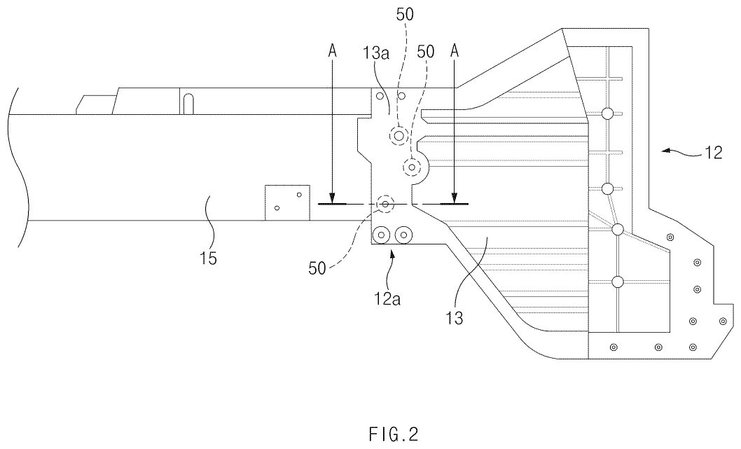

Referring to FIGS. 1 and 2, the dash crossmember 10 may further include a pair of outer plates 13 fixed to the pair of outrigger portions 12, respectively. A top edge of each outer plate 13 may be fixed to the top flange 42 of the corresponding outrigger portion 12 using fasteners, welding, and/or the like. A bottom edge of each outer plate 13 may be fixed to the bottom flange 43 of the corresponding outrigger portion 12 using fasteners, welding, and/or the like. Each outer plate 13 may at least partially cover the cavity of the corresponding outrigger portion 12. Stiffness of the outrigger portion 12 may be improved by the outer plate 13.

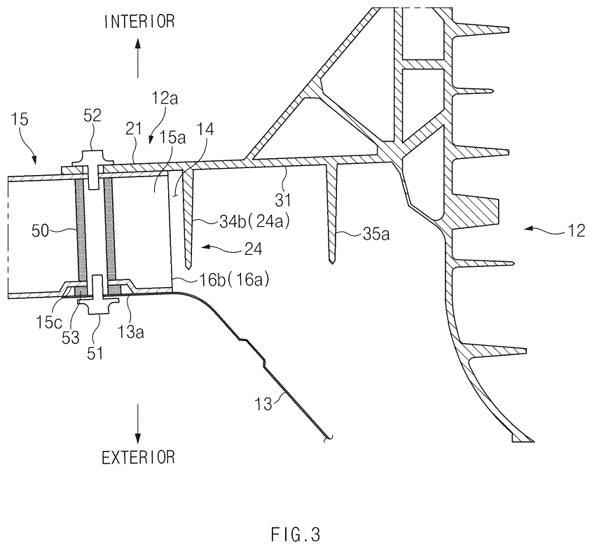

Each outrigger portion 12 may include a front connection portion 12a provided on a front portion thereof, and a rear portion 15a of each front side member 15 may be connected to the front connection portion 12a of the corresponding outrigger portion 12. Referring to FIG. 3, the front connection portion 12a may include a sidewall 21 connected to the sidewall 31 of the outrigger portion 12. Referring to FIG. 4, the front connection portion 12a may include a top wall 22 connected to the top wall 32 of the outrigger portion 12 and a bottom wall 23 connected to the bottom wall 33 of the outrigger portion 12.

Referring to FIG. 3, the front connection portion 12a may have a cavity 14 receiving the rear portion 15a of the front side member 15. The rear portion 15a of the front side member 15 may be received in the cavity 14 of the front connection portion 12a, and the rear portion 15a of the front side member 15 may be fixed to the front connection portion 12a using fasteners, welding, and/or the like. Each outer plate 13 may have a front extension portion 13a provided on a front portion thereof, and the front extension portion 13a of the outer plate 13 may be mounted on the front connection portion 12a using fasteners, welding, and/or the like. Accordingly, the front extension portion 13a may cover the cavity 14 of the front connection portion 12a. A top edge of the front extension portion 13a may be fixed to a top flange 42a of the front connection portion 12a using fasteners, welding, and/or the like. A bottom edge of the front extension portion 13a may be fixed to a bottom flange 43a of the front connection portion 12a using fasteners, welding, and/or the like.

Each front side member 15 may have an outboard-side wall facing the exterior of the vehicle and an inboard-side wall facing the interior of the vehicle. Referring to FIG. 1, a bracket 18 may be mounted on the top of each front side member 15.

Referring to FIGS. 2 and 3, a plurality of reinforcing pipes 50 may be disposed in the rear portion 15a of the front side member 15. Referring to FIG. 3, the reinforcing pipe 50 may extend in a width direction of the rear portion 15a of the front side member 15. A longitudinal axis of the reinforcing pipe 50 may be perpendicular to a longitudinal axis of the front side member 15. The reinforcing pipe 50 may be a nut having internal threads formed therein. A first end portion of the reinforcing pipe 50 may contact or be fixed to the outboard-side wall of the rear portion 15a of the front side member 15, and a second end portion of the reinforcing pipe 50 may contact or be fixed to the inboard-side wall of the rear portion 15a of the front side member 15. Stiffness of the rear portion 15a of the front side member 15 may be increased by the plurality of reinforcing pipes 50.

The front connection portion 12a of each outrigger portion 12 and the front extension portion 13a of the corresponding outer plate 13 may be fixed to the reinforcing pipe 50 by fasteners 51 and 52. Accordingly, the front connection portion 12a of each outrigger portion 12 and the front extension portion 13a of the corresponding outer plate 13 may be firmly joined to the rear portion 15a of the front side member 15 through the reinforcing pipe 50. Thus, crashworthiness of the vehicle body front structure may be improved, and safety of the passenger compartment may be secured. Referring to FIG. 3, the front extension portion 13a of the outer plate 13 may be fixed to the outboard-side wall of the rear portion 15a of the front side member 15 by a first bolt 51 screwed into the first end portion of the reinforcing pipe 50. The sidewall 21 of the front connection portion 12a may be fixed to the inboard-side wall of the rear portion 15a of the front side member 15 by a second bolt 52 screwed into the second end portion of the reinforcing pipe 50.

Referring to FIG. 3, the rear portion 15a of the front side member 15 may have a recess 15c formed in the outboard-side wall thereof. A nut 53 may be disposed between the recess 15c of the rear portion 15a of the front side member 15 and the front extension portion 13a of the outer plate 13, and the first bolt 51 may be screwed into the nut 53 and the reinforcing pipe 50.

Referring to FIG. 4, the front connection portion 12a may further include a support wall 24 connecting the top wall 22 and the bottom wall 23. The support wall 24 may have an upper inclined portion 24a extending obliquely from the top wall 22 at a predetermined angle and a lower inclined portion 24b extending obliquely from the bottom wall 23 at a predetermined angle. The upper inclined portion 24a and the lower inclined portion 24b may have a symmetrical shape, and a bottom end of the upper inclined portion 24a may be integrally connected to a top end of the lower inclined portion 24b so that the support wall 24 may have a V-like shape. The cavity 14 of the front connection portion 12a may be defined by the sidewall 21, the top wall 22, the bottom wall 23, and the support wall 24. The support wall 24 of the front connection portion 12a may be aligned with the rear portion 15a of the front side member 15 so that the rear portion 15a of the front side member 15 may be supported by the support wall 24 of the front connection portion 12a in the event of a vehicle collision/impact, and accordingly the rear portion 15a of the front side member 15 may be prevented from being pushed toward the rear of the vehicle.

Referring to FIG. 4, the rear portion 15a of the front side member 15 may have an upper inclined surface 16a and a lower inclined surface 16b provided on an end surface thereof. The upper inclined surface 16a of the front side member 15 may be aligned with the upper inclined portion 24a of the front connection portion 12a, and the upper inclined surface 16a and the upper inclined portion 24a may have the same inclined angle. The lower inclined surface 16b of the front side member 15 may be aligned with the lower inclined portion 24b of the front connection portion 12a, and the lower inclined surface 16b and the lower inclined portion 24b may have the same inclined angle.

Referring to FIG. 2, the plurality of reinforcing pipes 50 may be arranged in a triangular or V-like shape corresponding to the support wall 24.

Each outrigger portion 12 may have a plurality of ribs formed in the cavity thereof, and stiffness of the outrigger portion 12 may be improved by the plurality of ribs. Referring to FIG. 4, each outrigger portion 12 may include a plurality of reinforcing ribs 34a, 34b, 34c, 34d, and 34e extending in a longitudinal direction of the front side member 15. Some reinforcing ribs 34a, 34b, 34c, and 34d of the plurality of reinforcing ribs 34a, 34b, 340, 34d, and 34e may be aligned with the front side member 15 along a longitudinal direction of the vehicle. In the event of a vehicle collision/impact, an impact load may be uniformly distributed through the front side member 15 and the reinforcing ribs 34a, 34b, 34c, and 34d of the outrigger portion 12 aligned with the front side member 15, and accordingly deformation of the dash crossmember 10 may be reduced so that safety of the passenger compartment may be improved.

Referring to FIG. 4, each outrigger portion 12 may include a plurality of vertical ribs 35a, 35b, 35c, 35d, 35e, and 35f and a plurality of inclined ribs 36a, 36b, and 36c connected to the plurality of reinforcing ribs 34a, 34b, 340, 34d, and 34e. The plurality of vertical ribs 35a, 35b, 35c, 35d, 35e, and 35f may extend in a height direction of the vehicle, and the plurality of inclined ribs 36a, 36b, and 36c may extend in a diagonal direction.

As set forth above, according to exemplary embodiments of the present disclosure, the front connection portion of each outrigger portion and the front extension portion of the corresponding outer plate may be fixed to the reinforcing pipe by the fasteners so that the front connection portion of each outrigger portion and the front extension portion of the corresponding outer plate may be firmly joined to the rear portion of the front side member through the reinforcing pipe. Thus, the crashworthiness of the vehicle body front structure may be improved, and the safety of the passenger compartment may be secured.

According to exemplary embodiments of the present disclosure, the support wall of the front connection portion of each outrigger portion may be aligned with the rear portion of the corresponding front side member so that the rear portion of the front side member may be supported by the support wall of the front connection portion in the event of a vehicle collision/impact, and accordingly the rear portion of the front side member may be prevented from being pushed toward the rear of the vehicle.

According to exemplary embodiments of the present disclosure, in the event of a vehicle collision/impact, the impact load may be uniformly distributed through the front side member and the reinforcing ribs of the outrigger portion aligned with the front side member, and accordingly the deformation of the dash crossmember may be reduced so that the safety of the passenger compartment may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle body front structure comprising:
a dash crossmember comprising a cross portion extending in a width direction of a vehicle and a pair of outrigger portions disposed at both ends of the cross portion;
a pair of front side members extending from the pair of outrigger portions toward the front of the vehicle, wherein each outrigger portion of the pair of outrigger portions comprises a front connection portion having a cavity capable of receiving a rear portion of the corresponding front side member of the pair of front side members; and
a plurality of reinforcing pipes disposed in the rear portion of each front side member of the pair of front side members, each reinforcing pipe of the plurality of reinforcing pipes extending in a width direction of the front side member.

2. The vehicle body front structure according to claim 1, further comprising a pair of outer plates fixed to the pair of outrigger portions, respectively, wherein each outer plate of the pair of outer plates has a front extension portion mounted on the front connection portion of the corresponding outrigger portion of the pair of outrigger portions.

3. The vehicle body front structure according to claim 2, wherein the front connection portion of each outrigger portion of the pair of outrigger portions and the front extension portion of the corresponding outer plate of the pair of outer plates are fixed to the plurality of reinforcing pipes by fasteners.

4. The vehicle body front structure according to claim 3, wherein the front extension portion of each outer plate of the pair of outer plates is fixed to the rear portion of the corresponding front side member of the pair of front side members by a first bolt screwed into a first end portion of each reinforcing pipe of the plurality of reinforcing pipes.

5. The vehicle body front structure according to claim 4, wherein the front connection portion of each outrigger portion of the pair of outrigger portions is fixed to the rear portion of the corresponding front side member of the pair of front side members by a second bolt screwed into a second end portion of each reinforcing pipe of the plurality of reinforcing pipes.

6. The vehicle body front structure according to claim 3, wherein the front connection portion of each outrigger portion of the pair of outrigger portions is fixed to the rear portion of the corresponding front side member of the pair of front side members by a second bolt screwed into a second end portion of each reinforcing pipe of the plurality of reinforcing pipes.

7. The vehicle body front structure according to claim 1, wherein:
each outrigger portion of the pair of outrigger portions comprises a plurality of reinforcing ribs aligned with the corresponding front side member of the pair of front side members; and
each reinforcing rib of the plurality of reinforcing ribs extends in a longitudinal direction of the corresponding front side member of the pair of front side members.

8. A vehicle body front structure comprising:
a dash crossmember comprising a cross portion extending in a width direction of a vehicle and a pair of outrigger portions disposed at both ends of the cross portion;
a pair of front side members extending from the pair of outrigger portions toward the front of the vehicle, wherein each outrigger portion of the pair of outrigger portions comprises a front connection portion comprising:
a cavity capable of receiving a rear portion of the corresponding front side member of the pair of front side members; and
a support wall aligned with the rear portion of the corresponding front side member of the pair of front side members; and
a plurality of reinforcing pipes disposed in the rear portion of each front side member of the pair of front side members, each reinforcing pipe of the plurality of reinforcing pipes extending in a width direction of the front side member.

9. The vehicle body front structure according to claim 8, wherein:
the support wall has an upper inclined portion extending obliquely from a top wall of the front connection portion at a predetermined angle and a lower inclined portion extending obliquely from a bottom wall of the front connection portion at a predetermined angle;
the upper inclined portion and the lower inclined portion have a symmetrical shape; and
a bottom end of the upper inclined portion is integrally connected to a top end of the lower inclined portion.

10. The vehicle body front structure according to claim 9, wherein:
the rear portion of each front side member of the pair of front side members has an upper inclined surface and a lower inclined surface disposed on an end surface thereof;
the upper inclined surface is aligned with the upper inclined portion; and
the lower inclined surface is aligned with the lower inclined portion.

11. The vehicle body front structure according to claim 8, wherein the plurality of reinforcing pipes is arranged in a shape corresponding to the support wall.

12. The vehicle body front structure according to claim 8, further comprising a pair of outer plates fixed to the pair of outrigger portions, respectively, wherein each outer plate of the pair of outer plates has a front extension portion mounted on the front connection portion of the corresponding outrigger portion of the pair of outrigger portions.

13. The vehicle body front structure according to claim 12, wherein the front connection portion of each outrigger portion of the pair of outrigger portions and the front extension portion of the corresponding outer plate of the pair of outer plates are fixed to the plurality of reinforcing pipes by fasteners.

14. The vehicle body front structure according to claim 13, wherein the front extension portion of each outer plate of the pair of outer plates is fixed to the rear portion of the corresponding front side member of the pair of front side members by a first bolt screwed into a first end portion of each reinforcing pipe of the plurality of reinforcing pipes.

15. The vehicle body front structure according to claim 14, wherein the front connection portion of each outrigger portion of the pair of outrigger portions is fixed to the rear portion of the corresponding front side member of the pair of front side members by a second bolt screwed into a second end portion of each reinforcing pipe of the plurality of reinforcing pipes.

16. The vehicle body front structure according to claim 13, wherein the front connection portion of each outrigger portion of the pair of outrigger portions is fixed to the rear portion of the corresponding front side member of the pair of front side members by a second bolt screwed into a second end portion of each reinforcing pipe of the plurality of reinforcing pipes.

17. The vehicle body front structure according to claim 8, wherein: each outrigger portion of the pair of outrigger portions comprises a plurality of reinforcing ribs aligned with the corresponding front side member of the pair of front side members; and
each reinforcing rib of the plurality of reinforcing ribs extends in a longitudinal direction of the corresponding front side member of the pair of front side members.

18. A vehicle body front structure comprising:
a dash crossmember comprising a cross portion extending in a width direction of a vehicle and a pair of outrigger portions disposed at both ends of the cross portion;
a pair of front side members extending from the pair of outrigger portions toward the front of the vehicle, wherein each outrigger portion of the pair of outrigger portions comprises:
a front connection portion having a cavity capable of receiving a rear portion of the corresponding front side member of the pair of front side members; and
a plurality of reinforcing ribs aligned with the corresponding front side member of the pair of front side members, each reinforcing rib of the plurality of reinforcing ribs extending in a longitudinal direction of the corresponding front side member of the pair of front side members;
a pair of outer plates fixed to the pair of outrigger portions, respectively, wherein each outer plate of the pair of outer plates has a front extension portion mounted on the front connection portion of the corresponding outrigger portion of the pair of outrigger portions; and
a plurality of reinforcing pipes disposed in the rear portion of each front side member of the pair of front side members, each reinforcing pipe of the plurality of reinforcing pipes extending in a width direction of the front side member.

19. The vehicle body front structure according to claim 18, wherein the front connection portion of each outrigger portion of the pair of outrigger portions and the front extension portion of the corresponding outer plate of the pair of outer plates are fixed to the plurality of reinforcing pipes by fasteners.

20. The vehicle body front structure according to claim 19, wherein:
the front extension portion of each outer plate of the pair of outer plates is fixed to the rear portion of the corresponding front side member of the pair of front side members by a first bolt screwed into a first end portion of each reinforcing pipe of the plurality of reinforcing pipes; and
the front connection portion of each outrigger portion of the pair of outrigger portions is fixed to the rear portion of the corresponding front side member of the pair of front side members by a second bolt screwed into a second end portion of each reinforcing pipe of the plurality of reinforcing pipes.
